(19) United States
(12) Patent Application Publication
(10) Pub. No.: US 2007/0272215 A1
(43) Pub. Date: Nov. 29, 2007

(54) Fuel Injection Sytem for Internal Combustion Engines

(75) Inventors: Shmuel Huss, Cedarhurst, NY (US); Boris Feinleib, Jerusalem (IL)

Correspondence Address: NATH & ASSOCIATES, 112 South West Street, Alexandria, VA, 22314, US

(73) Assignee: MAZREK LTD., Jerusalem (IL)

(21) Appl. No.: 11/578,777

(22) PCT Filed:
(86) PCT No.: PCT/IL03/00747

(51) Int. Cl. F02M 51/00

(52) U.S. Cl. 123/476

(57) ABSTRACT

The fuel injection system for internal combustion engines comprises at least one hydraulically actuated intensifier-injector with inlet (13) and outlet (14) cavities for actuating fluid, one or more interconnected manifolds [rail(s)] (8); with at least one medium pressure pump (5), check valves (8, 9), coarse and fine purification filters (2, 4), a primary pump (3), a sump or tank (1), and electronic control unit (21) and a piping system. The exhaust actuating fluid (19) is fed to the medium pressure pump (5). A cooler (20) is installed between the exhaust of the injector (19) and the inlet (6) of medium pressure pump (5). The system allows driving the medium pressure pump(s) either from the engine crankshaft/camshaft, or autonomously by an electric motor, or by a secondary internal combustion engine. In the two latter cases, the common rail pressure, and respectively the injection pressure, is controlled by modifying the speed of the electric motor or of the secondary internal combustion engine.

### TECHNICAL FIELD

Present invention relates to the field of fuel supply devices for internal combustion engines, diesels in particular, and more specifically to systems that include a fuel pump-injector unit with a hydraulically driven pressure intensifier and a distributing device with an electro-magnetic control valve.

### BACKGROUND ART

Existing fuel injection systems comprise a hydraulically actuated (driven) pump-injector unit, a medium pressure common rail (up to 300 Bar) with check valves, a medium pressure boost pump with a feeding cavities, coarse and fine purification filters, a low pressure primary pump (up to 5 Bar), a sump (tank), an ECU and a hydraulic piping system.

The pressure intensifier of the said pump-injector unit includes an actuating piston and a pumping plunger. This pump-injector comprises a distributing device with an electro-magnetic control valve, a sprayer unit, inlet and outlet cavities for an actuating fluid and an exhaust for the actuating fluid.

These systems employ oil pumped from the engine lubrication system (sump) as the actuating fluid.

The disadvantage of the said systems is some rubber seals placed between oil cavities and cavities containing fuel (diesel) under high (injection) pressure (up to 2,000 Bar).

The said design reduces the reliability of the engine due to the fact that if the rubber seals fail, fuel (diesel) penetrates to the engine lubrication system; this leads to oil dilution, thus causing severe engine damage.

Some of the existing systems use fuel for the intensifier's actuating piston drive; the same fuel is also injected into the engine combustion chamber.

In the two above-mentioned systems, the actuating fluid is exhausted out of the injector and returned to the sump (tank).

Due to the relatively high flow capacity of the actuating fluid—that substantially exceeds the fuel quantity injected under high pressure into the engine combustion chamber (up to 15 times), and in order to ensure the system operation, one employs a high flow primary pump and high flow coarse and fine purification filters.

The above does not allow employing the regular (i.e., standard size) engine primary pump and filters, thus complicating the adaptation of the system to the existing diesels (retrofit).

A further disadvantage of the above systems is the excessive heating of the fuel (and/or of the oil) in the sump (tank) and in the entire system due to the influx of the hot exhausted actuating fluid to the sump (tank).

In the above systems the medium pressure pump is driven by the engine crankshaft/camshaft via the transmission system; the rotation frequency of the medium pressure pump is determined by the rotation frequency of the engine crankshaft/camshaft.

Varying the pressure in the (common) rail controls the injection pressure. This operation requires fuel bleeding from the (common) rail to the sump (tank) by an electromagnetic drain valve. This reduces the overall efficiency of the system.

The said disadvantages cause significant difficulties while adapting (retrofitting) the above systems to high-power diesels for heavy trucks, off-road vehicles, locomotives, power generation systems and marine applications.

### DISCLOSURE OF INVENTION

The present invention seeks to eliminate the need in the high flow capacity primary pump(s) and in the high flow capacity coarse and fine purification filters, but to allow the usage of the low flow capacity primary pump(s) and filters in a fuel injection system based on the hydraulically driven pump-injector unit(s) and pressure intensifier(s).

In accordance with the embodiment of the present invention, the proposed fuel injection system uses the fuel (diesel) as the actuating fluid and includes at least one hydraulically actuated (driven) pump-injector unit with the pressure intensification mechanism that comprises the actuating piston and the pumping plunger, the distributing device with the electro-magnetic control valve, the sprayer unit, the inlet and outlet cavities for the actuating fluid and one or more interconnected medium pressure common rails with a check valve, at least one medium pressure boost pump with a feeding cavity, the coarse and fine purification filters, the low pressure primary pump(s), the sump (tank), the ECU, the hydraulic piping system, as well as the cooler for the exhausted actuating fluid located in the hydraulic piping connecting the outlet cavity of the pump-injector unit with the feeding cavities of the medium pressure pump.

This simplifies the fuel system for both designs, OEM and RETROFIT, i.e., makes the design simpler, lowers size and weight, reduces the cost of new diesel engines and eases the adaptation (retrofit) of the proposed system to existing diesels due to preservation of the regular (standard) primary pump and the coarse and fine purification filters.

In addition, installation of a cooler in the piping between the pump-injector unit outlet cavity and the feeding cavities of the medium pressure pump prevents overheating of the actuating fluid (fuel) in the sump (tank) and in the entire system, substantially adding to the total safety.

The actuating fluid cooler may be a liquid-to-liquid or a liquid-to-air heat exchanger. The cooler must not be separate and can be integrated into the diesel cooling system as well.

To eliminate the rigid connection between the rotation frequency of the medium pressure pump drive and the rotation frequency of the engine crankshaft/camshaft, and therefore, the need in the fuel draining from the (common) rail to the sump (tank), while controlling the medium pressure level and therefore the injection pressure level respectively, in the proposed system it is possible to operate the medium pressure pump drive by either an electric motor or by an autonomous secondary internal combustion engine.

In this case, the pressure level in the (common) rail, and therefore, the injection pressure level respectively, is controlled by modifying the rotation frequency either of the electric motor or by the autonomous secondary internal combustion engine, while there is no need in fuel draining from the (common) rail. Thus, the overall engine efficiency increases.

To control the rotation frequency either by the said electric motor (performed by a controller) or by the secondary internal combustion engine, a signal sent by a pressure transducer installed in the (common) rail is used.

In the same time, the signal can be sent directly either to the electric motor controller or to the rotation frequency regulator of the secondary internal combustion engine, or via the ECU modifying the signal according to the running program.

To prevent disturbances and/or malfunction of the medium pressure pump due to pressure fluctuation in the (common) rail, a back pressure valve is installed between the medium pressure pump and the (common) rail.

### BRIEF DESCRIPTION OF DRAWINGS

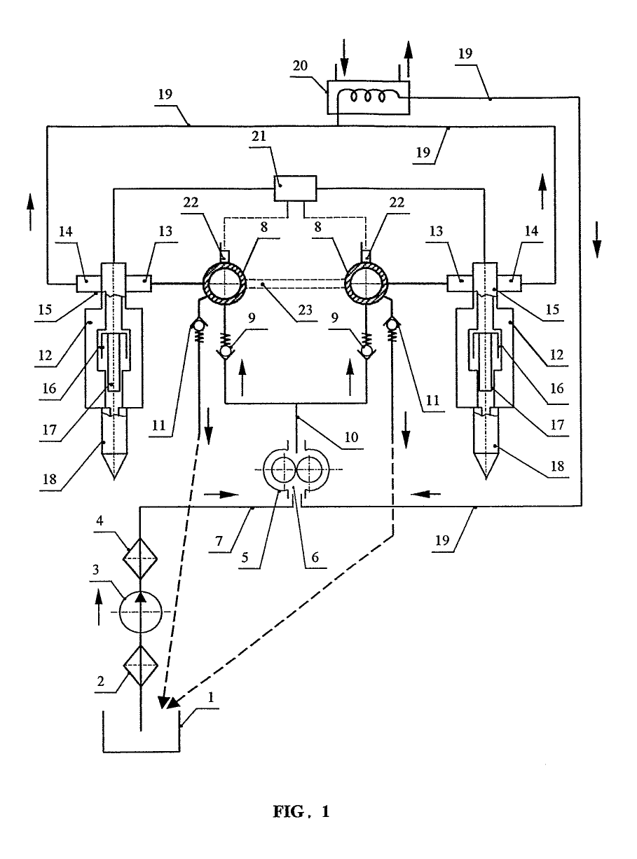

The present invention is better understood from the following drawing (FIG. 1) depicting a fuel injection system constructed and operative in accordance with an embodiment of this invention.

The proposed system functions as follows:

The low-pressure primary pump (3) pumps the actuating fluid (fuel) from the sump (tank) (1) through the coarse purification filter (2), and forces the actuating fluid through the fine purification filter (4) via the piping (7) into the medium pressure pump feeding cavities (6).

This pump drives the actuating fluid down the piping (10) through the back pressure valves (9) into the (common) rail (8) connected to the pump-injector unit inlet cavity (13). While activating the electro-magnetic control valve of the distributing device (15) on the arrival of a signal from the ECU (21) to the electromagnet, the actuating fluid reaches the pressure intensifier's actuating piston (16) through the distributing device (15).

The actuating piston forces and shifts the boost plunger (17) pumping the fuel through the sprayer unit (18) into the engine combustion chamber.

Upon the disconnection of the electric signal to the electro-magnet by the ECU (21), the distributing device (15) connects the pressure intensifier plunger outlet cavity with the pump-injector outlet cavity (13), and the exhausted actuating fluid flows down the piping (19) into the medium pressure pump feeding cavities (6).

The cooler (20) is installed in the piping (19) in order to cool the exhausted actuating fluid.

The check valve (11) is installed in the (common) rail (8) to protect it from pressure exceeding the set working values.

In the proposed system the fuel delivery per cycle (shot) is controlled by modifying the shape and the duration of the signal sent by the ECU (21) to the electro-magnets of the pump-injector unit's distributing device (15). The pump-injector unit injection pressure in the proposed system is momentarily determined by the modification of the (common) rail pressure; the pressure can be modified either by bleeding the fuel fluid from the (common) rail (8) into the sump (tank) (1) or by changing the medium pressure pump (5) delivery.

It will be appreciated that foregoing specification and drawing are set forth by the way of illustration and not limitation, and that various modifications and changes may be made without departing from the spirit and scope of the present invention.

### BEST MODE FOR CARRYING OUT THE INVENTION

In the proposed system, we may include one or more common rails. In the latter case, the common rails are interconnected by piping (23) in order to converge their inner pressure.

The proposed system can comprise one or more medium pressure pumps; each of these pumps can serve one or more pump-injector units. The pump drive may be performed in the traditional way—from the engine crankshaft/camshaft through the transmission. However, in this case there is a rigid connection between the rotation frequency of the medium pressure pump drive and the rotation frequency of the engine crankshaft/camshaft; this requires fuel bleeding from the (common) rail to the sump (tank) in order to control the fuel pressure in the (common) rail and the injection pressure level respectively. This configuration results in the reduction of the system's efficiency.

In order to prevent this, the system allows operating the medium pressure pump drive by either an electric motor or by an autonomous secondary internal combustion engine. Thus, one can control the pressure in the (common) rail by changing the rotation frequency of the medium pressure pump drive regardless of the engine crankshaft rotation frequency; respectively, modifying the medium pressure pump delivery controls the injection pressure. Modification of the medium pressure pump rotation frequency is performed either by a speed controller in charge of the electric motor rotation frequency or by a rotation frequency regulator of the autonomous secondary internal combustion engine. Moreover, while operating the controller or the rotation frequency regulator, a signal is sent by the pressure transducer (22) installed in the (common) rail. This signal can be sent directly either to the electric motor controller or to the rotation frequency regulator of the secondary internal combustion engine, or via the ECU modifying the signal according to the running program. The exhausted actuating fluid cooler (20) installed in the piping (19) may be a liquid-to-liquid or a liquid-to-air heat exchanger and constitute a component of the engine cooling system.

### INDUSTRIAL APPLICABILITY

The proposed fuel injection system can be applied for new diesel engines (OEM); it can be adapted (retrofitted) to existing diesels as well. This feature is one of the system's most significant and substantial advantages.

While adapting the proposed system on existing diesels, instead of the regular (traditional) injector, one installs a hydraulically actuated (driven) injector. Thus, there is no need in reconstruction of the existing engine cylinder heads. If the system comprises several pump-injector units, their inlet cavities are connected to a common inlet manifold. While employing several medium pressure pumps, their feeding cavities are connected to a common inlet manifold. At the same time, the existing medium pressure pumps can be reengineered, modernized and preserved. The medium pressure pump(s) can be driven either by the engine's crankshaft/camshaft through additional transmission or from the autonomous electric motor, or the autonomous secondary internal combustion engine can be used as well.

In the two latter cases there is no need to modify the engine construction (i.e., there is no need in transmission between the engine crankshaft/camshaft and the pump power shaft).

To adapt the system, one must install an additional (common) rail, while the primary low-pressure pump and the coarse and fine purification filters remain unchanged; this further simplifies the adaptation of the system on the existing diesel engines.

1. The fuel injection system for internal combustion engines, mainly diesels, comprising at least one hydraulically actuated (driven) pump-injector unit with pressure intensification that includes actuating piston and pumping plunger, a distributing device with an electro-magnetic control valve, a sprayer unit, inlet and outlet cavities for actuating fluid and an exhaust for actuating fluid, and one or more interconnected medium pressure (common) rail(s) with at least one medium pressure check valve, at least one medium pressure boost pump with a feeding cavities, coarse and fine purification filters, a low pressure primary pump, a sump (tank), an ECU and a hydraulic piping system, distinguished by the fact that the system uses fuel as the actuating fluid and the pump-injector unit outlet cavity is connected by piping to the medium pressure pump feeding cavities.

2. The fuel injection system according to claim 1, wherein if more than one pump-injector is used, their outlet cavities are connected to a common drain manifold.

3. The fuel injection system according to claim 1, wherein if more than one medium pressure pump is used, their feeding cavities are connected to a common inlet manifold (Rail).

4. The fuel injection system according to claim 1, wherein an exhausted actuating fluid cooler is installed in the said piping connecting the outlet cavity of the pump-injector and the feeding cavities of the medium pressure pump.

5. The fuel injection system according to claim 2, wherein an exhausted actuating fluid cooler is installed in the piping connecting the pump-injector unit common drain manifold and the medium pressure pump common inlet manifold.

6. The fuel injection system according to claim 4, wherein the liquid-to-liquid or liquid-to-air heat exchanger may serve as an exhausted actuating fluid cooler.

7. The fuel injection system according to claim 5, wherein the said heat exchanger is integrated into the engine cooling system.

8. The fuel injection system according to claim 1, wherein back pressure valves are installed in the said piping connecting the (common) rail and the medium pressure pump.

9. The fuel injection system according to claim 1, wherein the drive of the said medium pressure pump is performed from the engine crankshaft/camshaft via a transmission system.

10. The fuel injection system according to claim 1, wherein the drive of the said medium pressure pumps is performed either by an electric motor or by an autonomous secondary internal combustion engine.

11. The fuel injection system according to claim 10, wherein a controller is used to vary the rotation frequency of the said electric motor and a regulator is used to vary the rotation frequency of the secondary internal combustion engine.

12. The fuel injection system according to claim 11, wherein a signal sent by a pressure transducer installed in the (common) rail is used to control the said electric motor and the said secondary internal combustion engine rotation frequency.

13. The fuel injection system according to claim 12, wherein the said signal is sent by a pressure transducer either directly to the electric motor controller or the rotation frequency regulator of the secondary internal combustion engine, or via the ECU modifying the signal according to the running program.
